(19) United States
(12) Patent Application Publication
(10) Pub. No.: US 2013/0254536 A1
(43) Pub. Date: Sep. 26, 2013

(54) SECURE SERVER SIDE ENCRYPTION FOR ONLINE FILE SHARING AND COLLABORATION

(71) Applicant: WORKSHARE, LTD., London (GB)

(72) Inventor: Robin Glover, London (GB)

(73) Assignee: WORKSHARE, LTD., London (GB)

(21) Appl. No.: 13/799,067

(22) Filed: Mar. 13, 2013

Related U.S. Application Data
(60) Provisional application No. 61/614,380, filed on Mar. 22, 2012.

(51) Int. Cl. G06F 21/62

(52) U.S. Cl. CPC G06F 21/6209
USPC 713/165

(57) ABSTRACT

This invention discloses a novel system and method for securing files and folders containing files on a computer system whereby the files are encrypted using a hierarchy of encryption keys that permit authorized sharing but are resistant to tampering or hacking or other malicious access of the data.

### PRIORITY CLAIM

This application claims priority as a utility continuation of U.S. Provisional Patent Application No. 61/614,380 filed on Mar. 22, 2012, which is herein incorporated by reference in its entirety. This application herein incorporates by reference in its entirety U.S. patent application Ser. No. 13/333,605 filed on Dec. 21, 2011.

### FIELD OF INVENTION

The present invention generally relates to the field of document collaboration systems. More particularly, the present invention relates to methods and systems for securing files by means of hierarchical encryption controls.

### BACKGROUND

Online file and document storage and sharing services have a dilemma regarding how to deal with encryption of the uploaded content. The traditional approaches which involve encryption on the server are:
1. Do not encrypt uploaded content—the content is stored with no encryption on whatever basic storage medium is used by the service. This approach has serious disadvantages, including:
Vulnerability to illicit retrieval of content by staff or hackers
All content readable if storage medium is stolen physically or subject to unauthorized duplication
Coding errors which mean that access controls are not correctly applied will mean that users may gain access to other users documents
2. Encrypt all uploaded content using a single encryption key. While the storage medium is now secure if compromised, the single key becomes a point of risk. This approach has disadvantages:
The single encryption key must be known to each server on the system to allow it to encrypt and decrypt content. Hackers and/or staff may gain access to this key.
Once an unauthorized party has gained access to the single encryption key, all content becomes vulnerable in the same way as unencrypted content in approach 1.
3. Encrypt uploaded content using encryption keys that are generated (and different) on a per-user, per item or other basis. This approach also has disadvantages:
The generated keys must be stored in some fashion so that they are available to decrypt the content when it is downloaded. The server software must have functionality to access this storage and select the right key to decrypt a particular content item. Hackers who gain access to the system or steal a physical or virtual copy of one or more servers will be able to track this functionality and learn to recover the appropriate key for a particular piece of content.
If the key storage is compromised as described above then the system is vulnerable to data theft in the same way as an unencrypted system.
Sharing items between users to allow collaboration becomes troublesome under some key schemes (such as one encryption key per user)
4. Do it Yourself Management: Additionally, the user of any of the above services may choose to encrypt or password protect sensitive data before uploading. This would generally ensure that the data is secure while stored online (provided the encryption or password protection is not flawed), but has the following disadvantages:
The user must take responsibility for managing (storing and not losing) encryption keys and passwords.
When sharing with others, the user must take care of key or password distribution. Although this can be handled securely for public key style cryptography, secure key distribution is not possible for password protected content. Additionally, even where secure key distribution is possible it imposes a heavy burden on the user.
The user and anyone he shares the content with must have suitable software installed to handle encryption/decryption or password protection on the device used to access the content. This may exclude access from mobile devices and other non-PC computers.
The server provides no added value to the user as a secure platform—it simply acts as an online store of uploaded encrypted data. As a result of the self imposed encryption, the server cannot provide services such as
HTML or image based rendering of content for use on non-encryption capable devices
Document comparison or content management
Metadata scanning or removal
Other services requiring access to the content of the document on the server side.

As it stands, the user has a choice of either relying on an online content storage system that is fundamentally insecure but gaining useful functionality such as sharing management and other server side functions or taking responsibility for encryption and security themselves.

As a result, there is a need for a hierarchical arrangement of encryption and decryption keys that provides a range of access permissions and other controls. These and other objects, features and characteristics of the present invention will become more apparent to those skilled in the art from a study of the following detailed description in conjunction with the appended claims and drawings, all of which form a part of this specification. It should be understood that the description and specific examples are intended for purposes of illustration only and not intended to limit the scope of the present disclosure.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

FIG. 1. Flow chart depicting the process of creating file owner key pair.

FIG. 2. Flow chart depicting the encryption of a file using a file key pair.

FIG. 3. Flow chart depicting the access of a file by the file owner.

FIG. 4. Flow chart depicting sharing a file between User A and User B.

FIG. 5. Flow chart depicting securing a folder and providing access to the folder.

### DETAILED DESCRIPTION OF THE PREFERRED EMBODIMENTS

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The hierarchical server side encryption service involves organizing encryption keys. Each user of the service has a master encryption key, which is one of a private/public key pair. The user public key is stored on the server in plain text, that is, unencrypted form. An encrypted version of the user private key is stored on the server. This is encrypted using a further encryption key (referred to as the user secret key) supplied by the user, who provides it along with each request to the server that needs to access the user private key. The user secret key is not stored on the server, although irreversible cryptographic hashes of it may be stored (for example to verify that the user secret key that is input in response to a challenge is correct). The user secret key may be derived from a passphrase entered by the user or may be provided in some other way (for instance from a hardware token or a file stored on a removable device).

Encrypting Content: Each piece of content uploaded to the server is encrypted with a different, newly generated, key. This is referred to as the item key. The item key is stored in encrypted form. The item key is encrypted using the user's public key (which is available at all times on the server). The encrypted item key is stored in a database in order to associate it with an encrypted file. The unencrypted copy of the item key is discarded and never stored. To download an item from the server, the user sends their user secret key to the server as part of the download request. This allows the server to:
Decrypt the user's private key from the encrypted version which has been stored;
Use the user's private key to decrypt the item key; and
Use the item key to decrypt the item content and return the unencrypted item content to the user.

Once the request is complete, the server wipes the user secret key and the decrypted copies of the user private key and item key from memory or any other storage.

Content Sharing: Other actions that require access to the document content may also be carried out by the server in response to a request from the user that contains the user secret key. A content file can be shared with another user of the system by the following process:
The owner of the content item sends a share request to the server, accompanied by their user secret key;
The server uses the secret key to decrypt first the user private key, then the item key;
The server re-encrypts the item key with using the public key of the user with whom the item is to be shared; and
This newly encrypted copy of the item key is stored (typically alongside a permission record granting access to the item to the shared to user).

Now both users can download the item by providing their appropriate user secret keys. The server will automatically select the appropriate version of the encrypted item key to decrypt.

The advantages of this approach include that the information needed to decrypt any content item is never permanently stored on the server, making the system resilient to cyber-attacks. In particular, access to a copy of the server data store, software and encrypted content items is not sufficient to allow an attacker or malicious staff member to decrypt any user content. In addition, sharing content to other users is handled by the server, freeing the user from the need to worry about encryption key or password distribution. Furthermore, access permissions related to content items are backed up by the existence of or non-existence of the proper chain of encryption keys granting any user access to a content item. Thus, a programming error that causes the system to fail to apply access permissions to content will not result the server allowing users to download content they have no right to. Instead, the server will try (and fail) to decrypt the content item because there is no copy of the item key that has been encrypted with the user key of the unauthorized user.

Content could still be leaked to hackers, malicious staff or other attackers by means of compromise of the user's secret key (or the information that it is based on such as a passphrase). Since this is transferred to the server and processed on the server, precautions should be taken in handling this communication and processing, including communication to the server being secured by encryption—i.e. https, SSL etc. and that the server should take care to wipe the memory (and any other storage) used as interim storage of store this information when the decryption or encryption process is complete. An attacker who is able to take control of a server while it is operational may be able to monitor memory and capture any or all of user secret keys, user private keys, document keys and/or decrypted content item data. This is however a far more challenging task than extracting passwords and encryption keys from an offline server or database since the attack has to take place in real time and remain undetected by the operators of the service.

Consider a starting point of an online file sharing and collaboration system which has representations of users, folders, files and permissions. Examples might include dropbox and box.net. Such a basic service would be expected to have the following features:
Provision for users to register with an identifier (typically an email address) and a password to authenticate them.
Provision for the storage of files and the organization of files into folders.
Ability to upload new files and download files that have already been uploaded.
Ability to upload new versions of existing files and maintain a version history (see/download previous versions).
Ability to share files or folders (and all files within them) with other users.
Maintenance of access control lists (ACLs) which record which users are entitled to access the contents of which files and folders.
Storage of file contents in a file store of some description (hard disk, cloud storage, SAN/NAS etc).
Storage of other data (user details, file names, folder contents, ACLs etc) in some form of database (relational or otherwise) or equivalent data storage medium.

Given the typical collaboration or document sharing system, there are a series of essential functions. These are described below:
Creating Users on the System. When each user is registered with the system they must provide a unique piece of information (the user secret) which will be used as the basis of all encryption for that user. The user secret may be based on a text passphrase (which would be distinct from the user's logon password) or may be derived from some other source. The user secret can be transformed by the server into a symmetric encryption key (the user secret key) by a process such as a one way cryptographic hash. Techniques to derive encryption keys from passwords or other data such as those described in RFC 2898 may be used. The user secret is never stored on the server or in the server database or datastore, although a secure, one-way, cryptographic hash of the user secret may be stored to allow the server to validate that a supplied user secret is correct.

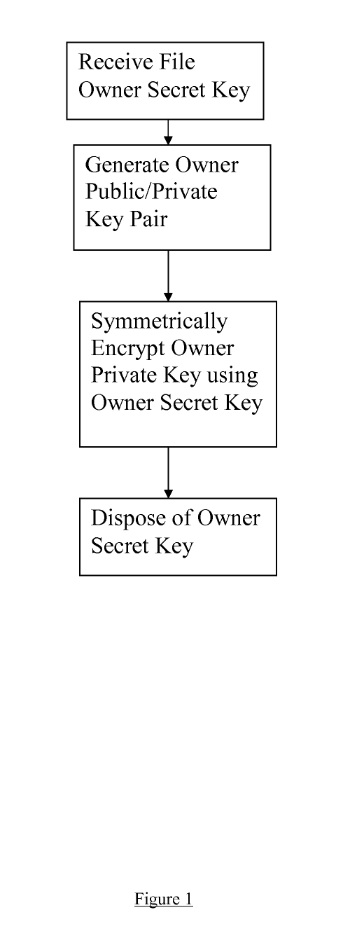

Upon registration of a new user the server will also create a new, randomly generated, public/private key pair. See FIG. 1. Various public key cryptography systems are suitable for the generation of this key pair, for instance RSA (Rivest-Shamir-Adleman) or ECC (Elliptic curve cryptography). The key length should be chosen with regard to the strength of encryption required for the file content. For instance recent recommendations indicate that an RSA key of 3072 bits or an ECC key of 256 bits should be used for equivalent security to an AES encryption at 128 bit strength. This key pair makes up the user private key and user public key. The public key of the generated key pair is stored in the server database along with the new user details. The private key is encrypted using the user secret key and a symmetric encryption algorithm (for instance AES) and the encrypted version is stored in the database along with the new user details. A one way cryptographic hash of the unencrypted user private key (for example an SHA256 hash) may also be stored in the database. In other embodiments, the symmetric encryption of the user's private key can be accomplished with non-symmetric encryption with appropriate protocols that secure the user private key so that it is only accessible when the user authorizes it. The notion is that the user private key used by the secure file storage system can only be accessed by means of the user submitting a passphrase or password that sufficiently secures the user private key.

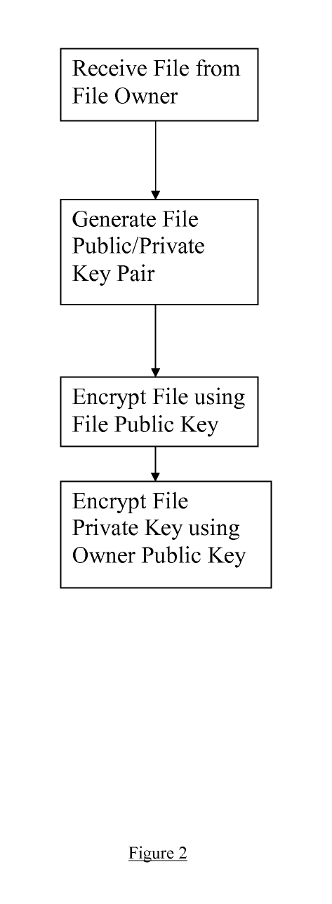

Uploading Files. When a new file is uploaded to the server, another new, randomly generated public/private key pair is created as described above. See FIG. 2. The private key from this pair is encrypted using the public key of the uploading user. The new public key and encrypted private key thus generated are stored in the server database alongside the data identifying the newly uploaded file. This key pair makes up the file private key and file public key. There is no need for the server to have access to the user passphrase or user secret key in order to perform a file upload. This allows automated uploads via a service without the need for the service to hold the user's secret information—for instance allowing a user to email files to be uploaded to a special email address. The newly uploaded file is encrypted using the file public key and the encrypted version of the file is stored by the server in its content store. A typical place to store this encrypted key would be alongside the permission record on the server that identifies the uploading server as having permission to access the newly uploaded file. It is normal practice when encrypting a large block of data with a public key cryptography scheme to actually create a random symmetric key (i.e. an AES key), encrypt the bulk data using that key and then encrypt the symmetric key using the public key cryptography. The stored data then includes the symmetric key encrypted using the file public key and the document data encrypted using the symmetric key. If updated versions of an existing file are uploaded to the server at any time, then they are encrypted using the existing file public key. In order to maintain maximum security the server may wipe the memory used to store the unencrypted version of the file contents and the various encryption keys used when the request is complete.

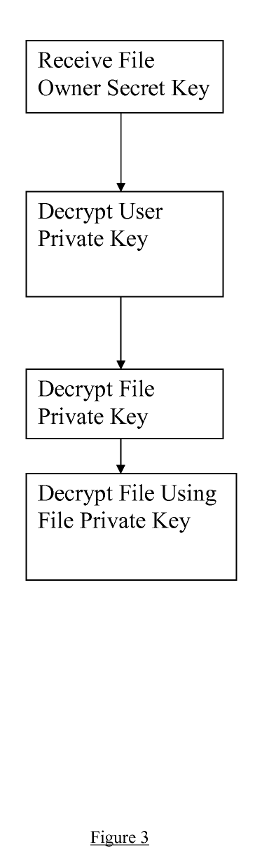

Downloading Files. In order to download a file the user makes a request to the server specifying which file and optionally which version of the file. Along with this request the user sends their user secret key or information sufficient to derive it (such as the passphrase from which it is generated). The user secret key is used to decrypt the encrypted version of the user private key (which has been retrieved from the database). The user private key is used to decrypt the encrypted version of the file private key (again, which has been retrieved from the database). The file private key is used to decrypt the file content and the decrypted file is then returned to the user. See FIG. 3. Where a symmetric key has been used to encrypt a large amount of data, the private file key is used to decrypt the symmetric key, which then is used to decrypt the file itself. In order to maintain maximum security the server may wipe the memory used to store the unencrypted version of the file contents and the various encryption keys used when the request is complete.

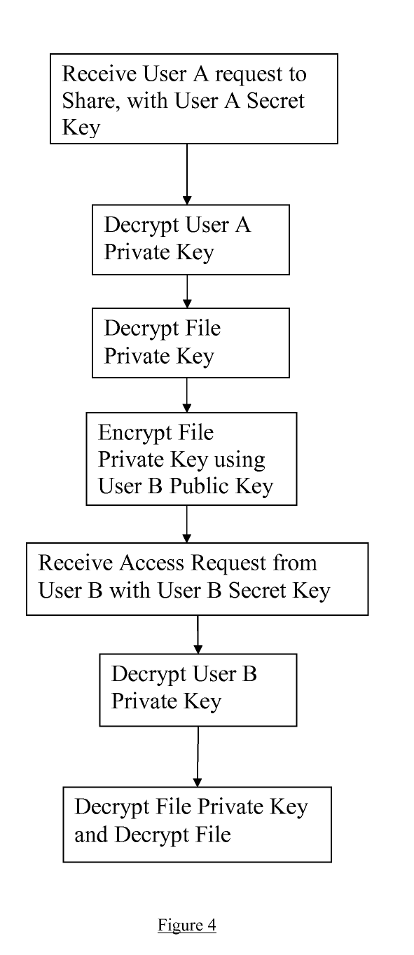

Sharing Files. The system and method can be further adapted to permit sharing of files between users. See FIG. 4. Assume that a file has been uploaded by a user ‘A’ who now wants to share that file with user ‘B’ so that user B can view and edit it. In order to enable this file sharing, user A makes a sharing request to the server specifying the file to share, who to share it with. Along with this request the user A sends their user secret key or information sufficient to derive it (such as the passphrase from which it is generated). Using that key, the system can retrieve the user A private key. Then the user A private key is used to derive the file private key for the file to be shared. The public key for user B is retrieved from the database and used to create a new encrypted version of the file private key. This second encrypted copy of the file private key is stored in the database, possibly together with the new permissions record that will grant user B access to the file. Note that the original copy of the encrypted file private key is not overwritten or replaced—after completing the sharing procedure there are now two separate encrypted copies of the file private key stored, one for each user who has access. Sharing to more than one additional user proceeds in the same manner (the sharing request may allow multiple recipients to be specified or multiple requests may be made). A separate encrypted version of the file private key is stored corresponding to each user who is granted access to the file.

When a user sends a request to download a file the correct encrypted copy of the file private key is selected by the server. This is accomplished by verifying the user using the user's secret key and then retrieving the version of the encrypted file private key created using that user's public key, and therefore associated with that user. If a user attempts to download a file to which they have not been granted access, they will have no way to obtain a correctly decrypted copy of the file private key, and therefore no way to access the file contents. This restriction applies independently to any code on the server which checks for permissions for a user to access a file. If the sharing permission to a user is revoked, then the version of encrypted file private key will be discarded from the database along with removing any permissions record that grants access to that user to the file.

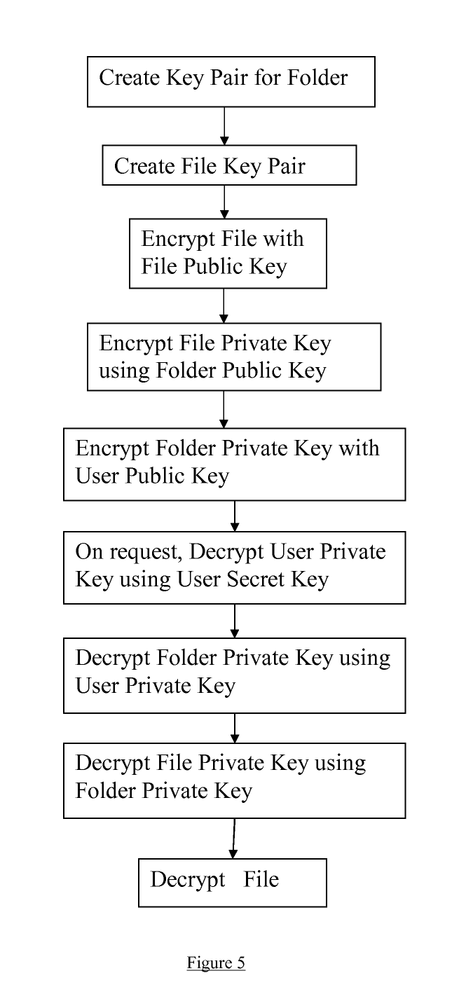

Sharing Folders. The system can also be adapted to share entire folders. See FIG. 5. Sharing folders requires additional complexity. It is not sufficient to just treat the action of sharing a folder with user B as equivalent to sharing each file in the folder with user B. That would give user B access to the private file key for all existing files in the folder, but they would not gain access to the encryption keys for files subsequently added to the folder. Instead, when a new folder is created (including a top level folder), a new public/private key pair is created for the entire folder. This pair makes up the folder private key and folder public key. The folder public key is stored in the database alongside the information making up the folder record.

The folder private key is encrypted with the creating user's public key. The encrypted folder private key is stored in the database, most likely along with the record that grants the creating user permission to access the folder. When a new item (file or subfolder) is created within any folder, the (file or folder) private key of the newly created item is encrypted with the public key of the containing folder. This encrypted copy of the new item private key is stored in the database, possibly alongside the data identifying the new item itself. When a folder is shared to a different user, the steps for sharing files are carried out, but using the folder private key rather than the file private key. Thus at the end of the steps the database contains a version of the folder private key encrypted with the public key of the user who is being granted permission to access the folder.

Downloading a file from a shared folder. When downloading a file from a folder that has been shared to the user, there will be no copy of the file private key encrypted by the user's public key. At this point the server will check the parent folder of the file (and its parent folders) looking for a folder where the user has been granted permission. The database will contain a copy of this folder's private key encrypted with the user's public key. The user's encrypted private key is retrieved from the database and decrypted using the user secret key. The user's private key is used to decrypt the encrypted folder private key found above. The folder private key can be used to decrypt the file or folder private key for any item contained in that folder. This allows access either directly to the private key of the file to be downloaded or indirectly (via decrypting the private keys of intermediate folders between the shared folder and the file).

Changing the User Secret Key. In order to update the user secret key—for instance change the passphrase if the secret is based upon a passphrase—the user must provide the server with both the existing and new user secret keys (or equivalently information that can be used to calculate them, such as the existing and new passphrase). The server decrypts the user private key using the existing user secret key and then re-encrypts it using the new user secret key. The newly re-encrypted user private key is then stored in the database replacing the original encrypted user private key.

Resetting the User Secret Key. If the user no longer has access to their user secret key (for example they have forgotten the passphrase which is used to generate it), they cannot use the mechanism described above to reset it. If the user no longer has access to their user secret key and has no means to reset it, they will be unable to access any of their files. This is unacceptable from a usability point of view, so the below are described techniques that may be used to allow recovery from user secret key loss while maintaining security.

Storing a User Private Key backup on the Client. The server may provide a mechanism for the user to download and backup their private key in unencrypted form. The request to download the private key must be accompanied by the user secret key in order to allow the server to decrypt the encrypted private key, so the encryption key can only be backed up by a user who is still in possession of their user secret key. The user should store the backed up private key securely. If a user who has forgotten their passphrase or otherwise lost their user secret key has kept a backup of their unencrypted user private key, the server may offer a mechanism for the user to re-upload their backed up user private key along with a new user secret key. If the server has stored a cryptographic hash of the user private key the server can validate that the correct private key is being uploaded. The server must also validate the identity of the uploading user in some other manner to ensure that the reset of the user secret key is not being carried out by an unauthorized user. Providing the user is authenticated properly and the correct private key is uploaded, the server can encrypt the user private key using the new user secret key and then store this new encrypted copy of the user private key in the database. The new user secret key will allow the user access to all of their existing files and folders.

Storing a User Private Key backup on the Server. If the user is unable or unwilling to keep a backup of their user private key, it is possible for the server to store a backup on their behalf. In order to avoid breaching the security of the system, the backup of the user private key on the server must be encrypted and the encryption key must not be stored on the server. The backup of the user private key must therefore be stored on the server encrypted using a key based on information provided by the user. If, at a later point the user is able to provide the same information again, the same key will be generated and the user private key will be decrypted correctly. One approach to this problem is to request that the user give answers that are easily memorable to a number of questions. Typical questions might be ‘What was your town or place of birth?’, ‘What was the name of your first pet?’, ‘What was the name of your first school?’.

Depending on the level of security required, the structure of the encrypted key stored may be varied. For the highest security, the user would need to provide answers to a number of questions, and a single encryption key would be generated from all the answers. This key would then be used to encrypt the user private key and the result would be stored. The user would have to provide exactly the same answers to all the questions to recover the private key at a later time. For a less secure but more usable approach, the user would also need to provide answers to a number of questions. Each answer would be used separately to produce an encryption key and generate an encrypted version of the user private key. All of these versions of the encrypted user private key would be stored. At a later time, the user would only need to answer one of the questions correctly to be able to decrypt and recover the private key. Other balances between security and ease can be devised—for instance it would be possible to ask the user 4 questions and store 6 copies of the encrypted private key under different encryptions (each copy encrypted by a different pair of answers selected from the 4 questions). In this way the user would be required to answer any 2 questions from 4 correctly to recover their private key.

Storing a User Private Key Backup via an Admin User. If the server provides for a hierarchy of users or the facility for administrative users, backups of users private keys may be stored in the database encrypted by the public key of the user's administrator. When a new user is created and the new user's public and private key are generated, a copy of the private key is encrypted using the public key of the user's administrator and then stored in the database.

At a later date, the administrator may provide their user secret key to the server which can then decrypt the administrator's private key, which can then be used to decrypt the private key of any user for which the administrator is responsible. In a corporate environment, the administrator described here would typically be the CIO or someone reporting to the CIO rather than a computer system administrator. By virtue of their ability to access any user's private key the administrator can indirectly access any file stored by one of their users. This property is desirable as it allows the administrator to access the files of a user who has (for example) left the organization, however it requires the administrator to be fully trusted by the organization.

### Operating Environment:

Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

In some instances, especially where the mobile computing device 104 is used to access web content through the network 110 (e.g., when a 3G or an LTE service of the phone 102 is used to connect to the network 110), the network 110 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The user's computer may be a laptop or desktop type of personal computer. It can also be a cell phone, smart phone or other handheld device, including a tablet. The precise form factor of the user's computer does not limit the claimed invention. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The system and method described herein can be executed using a computer system, generally comprised of a central processing unit (CPU) that is operatively connected to a memory device, data input and output circuitry (I/O) and computer data network communication circuitry. A video display device may be operatively connected through the I/O circuitry to the CPU. Components that are operatively connected to the CPU using the I/O circuitry include microphones, for digitally recording sound, and video camera, for digitally recording images or video. Audio and video may be recorded simultaneously as an audio visual recording. The I/O circuitry can also be operatively connected to an audio loudspeaker in order to render digital audio data into audible sound. Audio and video may be rendered through the loudspeaker and display device separately or in combination. Computer code executed by the CPU can take data received by the data communication circuitry and store it in the memory device. In addition, the CPU can take data from the I/O circuitry and store it in the memory device. Further, the CPU can take data from a memory device and output it through the I/O circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades. The user interface also displays a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a 2 dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

The system is typically comprised of a central server that is connected by a data network to a user's computer. The central server may be comprised of one or more computers connected to one or more mass storage devices. The precise architecture of the central server does not limit the claimed invention. In addition, the data network may operate with several levels, such that the user's computer is connected through a fire wall to one server, which routes communications to another server that executes the disclosed methods. The precise details of the data network architecture do not limit the claimed invention.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Further, a server may be virtual, whereby several software instances each operating as an independent server are housed in the same hardware computer. Practitioners of ordinary skill will recognize that functions that are accomplished on one server may be partitioned and accomplished on multiple servers that are operatively connected by a computer network by means of appropriate inter process communication. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML or scripting languages that are executed by Internet web-browsers) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the specification is intended only to provide an extremely detailed disclosure of the present invention and is not intended to be limiting.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Also, while processes or blocks are at times shown as being performed in series, these processes or blocks may instead be performed or implemented in parallel, or may be performed at different times.

What is claimed:

1. A method for storing and accessing documents on a server comprising:
receiving a data file from a remote computer operated by a user;
generating a public/private key pair associated with the user;
generating a public/private key pair associated with the received file;
encrypting the received file using the file public key;
encrypting the file private key using the user public key; and
encrypting the user private key.

2. The method of claim 1 further comprising:
decrypting the user private key;
decrypting the file private key using the decrypted user private key; and
decrypting the file using the decrypted file private key.

3. The method of claim 1 further comprising:
receiving a request from the user computer to share the file with an additional user, said additional user being associated with a public/private key pair unique to the additional user;
decrypting the requesting user private key;
decrypting the file private key using the user private key;
retrieving the additional user public key; and
encrypting the file private key with the additional user public key.

4. The method of claim 3 further comprising:
receiving and access request from the additional user;
verifying the access request;
decrypting the additional user private key;
decrypting the file private key using the additional user private key; and
decrypting the file.

5. A method for storing and accessing documents on a server comprising:
receiving a data file from a computer operated by a user to be stored in a folder, said user being associated with a user public/private key pair and said file having an associated public/private key pair;
creating a public/private key pair associated with directory folder;
encrypting the received file using the file public key;
encrypting the file private key using the folder public key; and
encrypting the folder private key using the user public key.

6. The method of claim 5 further comprising:
encrypting the folder private key using a plurality of public keys, said public keys corresponding to associated private keys in a key pair, each said key pair associated with a corresponding plurality of users authorized to access files in the folder.

7. The method of claim 6 further comprising:
receiving a request from a computer operated by an authorized user to access the file in the folder;
decrypting the authorized user private key;
decrypting the folder private key using the authorized user private key;
decrypting the file private key using the folder private key; and
decrypting the file.

8. The method of claim 1 further comprising:
storing in a data structure for the user, a user identifier, the user's encrypted private key and the user's public key;
storing in a data structure for the file, a file identifier, the file's encrypted private key using the user's private key and the file's public key.

9. The method of claim 7 further comprising:
storing in a data structure for the user, a user identifier, the user's encrypted private key and the user's public key;
storing in a data structure for the file, a file identifier, the file's encrypted private key using the user's private key and the file's public key; and
storing in a data structure for the folder, a folder identifier, the folder's encrypted private key using the user's private key and the folder's public key.

10. The method of claim 1 where the step of encrypting the user private key is comprised of:
receiving a secret key from the user remote computer; and
encrypting the user private key using a symmetric encryption algorithm using the received secret key.

11. The method of claim 1 where the encrypting the received file step is comprised of:
encrypting the received data file using a symmetric encryption algorithm with a pre-determined symmetric encryption key; and
encrypting the symmetric key using the file public key.

12. The method of claim 2 where the decrypting the file step is comprised of:
decrypting the symmetric key using the file private key; and
decrypting the data file using a symmetric encryption algorithm with the decrypted symmetric key.

13. The method of claim 8 further comprising storing data representing an access permission value associated with the file and with the user.

14. The method of claim 1 where the encrypting the user private key step is further comprised of:
receiving a secret key from the user's computer; and
encrypting the user's private key using the received secret key.

15. The method of claim 14 further comprising:
receiving from a user's remote computer the user secret key and a replacement user secret key; and
decrypting the user private key using the user secret key; and
re-encrypting the user private key using the replacement user secret key.

16. The method of claim 1 further comprising:
encrypting the user private key using a public key of a public/private key pair associated with a permission level senior to the user; and
storing the encrypted private key in a database.

17. A computer system adapted to perform any of the methods of claims 1-16.

18. A computer readable data storage device comprised of programming code, that when executed, causes the computer to execute any of the claims 1-16.

19. A system for storing and accessing documents on a server comprising:
a component adapted for receiving a data file from a remote computer operated by a user;
a component adapted for generating a public/private key pair associated with the user;
a component adapted for generating a public/private key pair associated with the received file;
a component adapted for encrypting the received file using the file public key;
a component adapted for encrypting the file private key using the user public key; and
a component adapted for encrypting the user private key.

20. The system of claim 19 further comprising:
a component adapted for decrypting the user private key;
a component adapted for decrypting the file private key using the decrypted user private key; and
a component adapted for decrypting the file using the decrypted file private key.

21. The system of claim 19 further comprising:
a component adapted for receiving a request from the user computer to share the file with an additional user, said additional user being associated with a public/private key pair unique to the additional user;
a component adapted for decrypting the requesting user private key;
a component adapted for decrypting the file private key using the user private key;
a component adapted for retrieving the additional user public key; and
a component adapted for encrypting the file private key with the additional user public key.

22. The system of claim 21 further comprising:
a component adapted for receiving and access request from the additional user;
a component adapted for verifying the access request;
a component adapted for decrypting the additional user private key;
a component adapted for decrypting the file private key using the additional user private key; and
a component adapted for decrypting the file.
